(19) United States
(12) Patent Application Publication
(10) Pub. No.: US 2011/0255126 A1
(43) Pub. Date: Oct. 20, 2011

(54) PRINTING APPARATUS, PRINT PROCESSING METHOD, AND PROGRAM

(75) Inventor: Shunsuke Iguchi, Tokyo (JP)

(73) Assignee: CANON KABUSHIKI KAISHA, Tokyo (JP)

(21) Appl. No.: 12/991,124

(22) PCT Filed: Sep. 7, 2010
(86) PCT No.: PCT/JP2010/005488

§ 371 Date: Nov. 4, 2010

(30) Foreign Application Priority Data
Sep. 18, 2009 (JP) 2009-217267

(51) Int. Cl. G06K 15/02

(52) U.S. Cl. 358/1.15

(57) ABSTRACT

It is an object to automatically avoid the occurrence of a cycle down. The object is accomplished by having transfer means for, when information has been added to a record, holding a page image which is formed by forming means until page images of all page data included in the record are formed by the forming means and transferring the held page images of all of the page data included in the record to a printer engine, and when the information is not added to the record, each time the page image of the page data included in the record is formed by the forming means, transferring the formed page image to the printer engine.

### TECHNICAL FIELD

The invention relates to a printing apparatus, a print processing method, and a program.

### BACKGROUND ART

In recent years, a variable printing in which a plurality of variable data are overlaid with fixed data and a large quantity of pages are printed at a high speed has been used. Various kinds of PDLs (Page Description Languages) for efficiently performing the printing by using variable data have also been developed.

For example, there is a PPML (Personalized Print Markup Language) which has been standardized by a PODi (Print On Demand Initiative). Refer to PPML Functional Specification, Version 2.2 (http://www.podi.org/) for details. There is also a PDF/VT which has been standardized in an ISO (International Organization for Standardization). Refer to ISO/CD 16612-2: Graphic technology—Variable data exchange—Part 2: Using PDF/X-4 and PDF/X-5 (PDF/VT-1 and PDF/VT-2) for details.

In those PDLs, an object obtained by executing a drawing (Raster Image Processing: RIP) process to a fixed object (reusable object) is stored (cached) into a storing device. By extracting the cached object, RIP-processing the variable data, and overlaying the resultant data, control can be made so that such a situation that a fixed region is repetitively RIP-processed is avoided and a process can be executed at a high speed.

In a printing apparatus, as a method of printing received PDL data, there is a method called an RIP-Then print in which all pages included in the received PDL data are RIP-processed and, thereafter, the printing is started. There is also a method called an RIP-While print in which the received PDL data is successively RIP-processed and immediately after a page was formed, it is printed.

Particularly, in the case of a print job including a large quantity of pages, a printing method called a Gallop mode in which pages up to a set print start page number are RIP-processed and, thereafter, the printing is started is also used. Refer to WHITE PAPER, FreeFlow Variable Information Workflow, Prepared by INTERQUEST, Ltd., XEROX Corporation (2004) for details.

A case of executing the foregoing RIP-While print will now be considered. In the case where the received PDL data is complicated for a print speed (engine speed) of a printing apparatus (engine), a case where a speed (RIP speed) at which the printing apparatus RIP-processes the PDL data and forms the page is lower than the engine speed.

Generally, the printing apparatus can perform only the printing while keeping a predetermined print speed. For example, in the case where the RIP process can be executed only at a speed of 40 sheets per minute for the printing apparatus which can print 60 sheets per minute, it is difficult that the printing apparatus decreases the print speed according to the RIP speed, so that the printing apparatus temporarily stops the operation (cycle down). If the printing apparatus stopped the operation, it takes a further long time in order to restart the operation. There is, consequently, such a problem that if the RIP speed becomes lower than the print speed, the print speed further decreases by a value lager than the decreased value of the RIP speed.

Particularly, in the case of a variable print job, in many cases, since a cache is invalid at an initial stage of the job, the RIP speed decreases remarkably. Consequently, in many cases, the cycle down occurs at the initial stage of the job and the print speed decreases.

FIG. 1A is a graph illustrating a problem in the case of performing the RIP-While print in the variable print job.

An axis of ordinate indicates the accumulated number of print sheets and an axis of abscissa indicates a time. A graph 101 is a graph showing the RIP speed of the variable print job. A graph 102 is a graph showing an ideal engine speed. When the RIP speed of the variable print job is lower than the engine speed, the printing apparatus cannot decrease the engine speed according to the RIP speed. Therefore, the printing apparatus must stop the engine and wait until the page is formed by the RIP process (cycle down).

A graph 103 is a graph showing a print speed based on a sheet discharge in which such a cycle down has occurred.

At the initial stage of the print job, the RIP speed is lower than the engine speed. Therefore, the cycle down occurs and, as for the actual print speed, the printing is performed at a speed which is fairly lower than the RIP speed. It will be understood that when an effect of the cache of a usable object appears in the variable print job and the RIP speed rises, the printing can be performed at the same print speed as the engine speed.

FIG. 1B is a graph illustrating a case of using the Gallop mode for the variable print job of FIG. 1A.

A graph 120 is a graph showing a print speed in the case of using the Gallop mode. In the case of a job using the Gallop mode, the user must preliminarily set a print start page number 121.

FIG. 2 is a diagram illustrating a total time in the case of performing the RIP-While print and the Gallop mode printing in the variable print job.

As compared with a time 201 required for the RIP, an actual print time 202 is longer than the time required for the RIP due to the occurrence of the cycle down. In a Gallop mode print time 203, since the printing is performed after waiting for the printing, the cycle down does not occur.

In the Gallop mode printing, since the printing apparatus executes the RIP process and subsequently performs the printing until the print page reaches the designated print start page number 121, the cycle down can be avoided even in the variable print job at the RIP speed as shown by the graph 101. However, in the Gallop mode, the print start page number 121 has to be manually set. If the print start page number 121 is set to a small page number, that is, if it is set to such a value that the printing is started early, the RIP speed is not in time and there is a possibility of occurrence of the cycle down. On the contrary, if the print start page number 121 is set to a large page number, that is, if it is set to such a value that the printing is started after waiting for a necessary time or longer, although the possibility of occurrence of the cycle down can be avoided, it takes a surplus print time. Further, with respect to VDP data to be printed, it is difficult for the user to discriminate its RIP load at a glance. Thus, it is also difficult to set the print start page number 121 to the optimum page number.

### CITATION LIST

### Non Patent Literature

NPL1: WHITE PAPER, FreeFlow Variable Information Workflow, Prepared by INTERQUEST, Ltd., XEROX Corporation (2004)

NPL2: ISO/CD 16612-2: Graphic technology—Variable data exchange—Part 2: Using PDF/X-4 and PDF/X-5 (PDF/VT-1 and PDF/VT-2)

### Others

Others1: PPML Functional Specification, Version 2.2 (http://www.podi.org/)

### SUMMARY OF INVENTION

### Technical Problem

The invention is made in consideration of such a problem and it is an object of the invention to automatically avoid the occurrence of a cycle down.

### Solution to Problem

The present invention provides a printing apparatus which comprises: input means for inputting print data including a plurality of records each including a plurality of page data each containing either one or both of reusable data and variable data; extracting means for extracting the reusable data every record; adding means for, when the reusable data which has been extracted for the first time in the print data is included in the reusable data extracted by the extracting means, adding information to the record including the first-extracted reusable data; forming means for forming a page image every page data included in the record; and transfer means for, in the case where the information has been added to the record, holding the page images which are formed by the forming means until the page images of all of the page data included in the record are formed by the forming means and transferring the held page images of all of the page data included in the record to a printer engine, and in the case where the information is not added to the record, each time the page image of the page data included in the record is formed by the forming means, transferring the formed page image to the printer engine.

The present invention further provides a printing apparatus which comprises: input means for inputting print data including a plurality of records each including a plurality of page data each containing either one or both of reusable data and variable data; extracting means for extracting the reusable data every page data included in the record; adding means for, when the reusable data which has been extracted for the first time in the print data is included in the reusable data extracted by the extracting means, adding information to the page data including the reusable data; forming means for forming a page image every page data included in the record; and transfer means for, in the case where the information has been added to the page data of the page image formed by the forming means, holding the page images formed by the forming means, and in the case where the information is not added to the page data of the page image formed by the forming means, transferring the page image formed by the forming means and the page images which have already been held to a printer engine.

### Advantageous Effects of Invention

According to the invention, the occurrence of the cycle down can be automatically avoided.

### BRIEF DESCRIPTION OF DRAWINGS

[FIG. 1A]

FIG. 1A is a diagram each illustrating a graph showing a problem in the case of performing an RIP-While print in a variable print job.

[FIG. 1B]

FIG. 1B is a diagram each illustrating a graph showing a problem in the case of performing an RIP-While print in a variable print job.

[FIG. 2]

FIG. 2 is a diagram illustrating a total time in the case of performing the RIP-While print and a Gallop mode printing in the variable print job.

[FIG. 3]

FIG. 3 is a diagram illustrating an example of a hardware construction of a printing apparatus for executing a variable printing.

[FIG. 4]

FIG. 4 is a diagram illustrating an example of software modules of the printing apparatus for executing the variable printing.

[FIG. 5]

FIG. 5 is a diagram illustrating an example of a construction of a PPML as a variable print job.

[FIG. 6A]

FIG. 6A is a diagram illustrating print results and an RIP processing time of the variable print job.

[FIG. 6B]

FIG. 6B is a diagram illustrating print results and an RIP processing time of the variable print job.

[FIG. 7A]

FIG. 7A is a flowchart for describing a print process of the printing apparatus in an embodiment 1.

[FIG. 7B]

FIG. 7B is a flowchart for describing a print process of the printing apparatus in an embodiment 1.

[FIG. 7B-1]

FIG. 7B-1 is a continuation flowchart of FIG. 7B.

[FIG. 8]

FIG. 8 is a diagram illustrating examples of developed record information.

[FIG. 9A]

FIG. 9A is a diagram illustrating an RIP speed and an engine speed in the variable print job.

[FIG. 9B]

FIG. 9B is a diagram illustrating an RIP speed and an engine speed in the variable print job.

[FIG. 10A]

FIG. 10A is a diagram illustrating an RIP speed and an engine speed in the variable print job in the embodiment 1.

[FIG. 10B]

FIG. 10B is a diagram illustrating an RIP speed and an engine speed in the variable print job in the embodiment 1.

[FIG. 11A]

FIG. 11A is a flowchart for describing a print process of a printing apparatus in an embodiment 2.

[FIG. 11B]

FIG. 11B is a flowchart for describing a print process of a printing apparatus in an embodiment 2.

[FIG. 11B-1]

FIG. 11B-1 is a continuation flowchart of FIG. 11B.

[FIG. 12]

FIG. 12 is a flowchart for describing a print process for discriminating a first-appearing reusable object interval in an embodiment 3.

[FIG. 13]

FIG. 13 is a flowchart for describing a print process for discriminating a first-appearing reusable object interval in an embodiment 4.

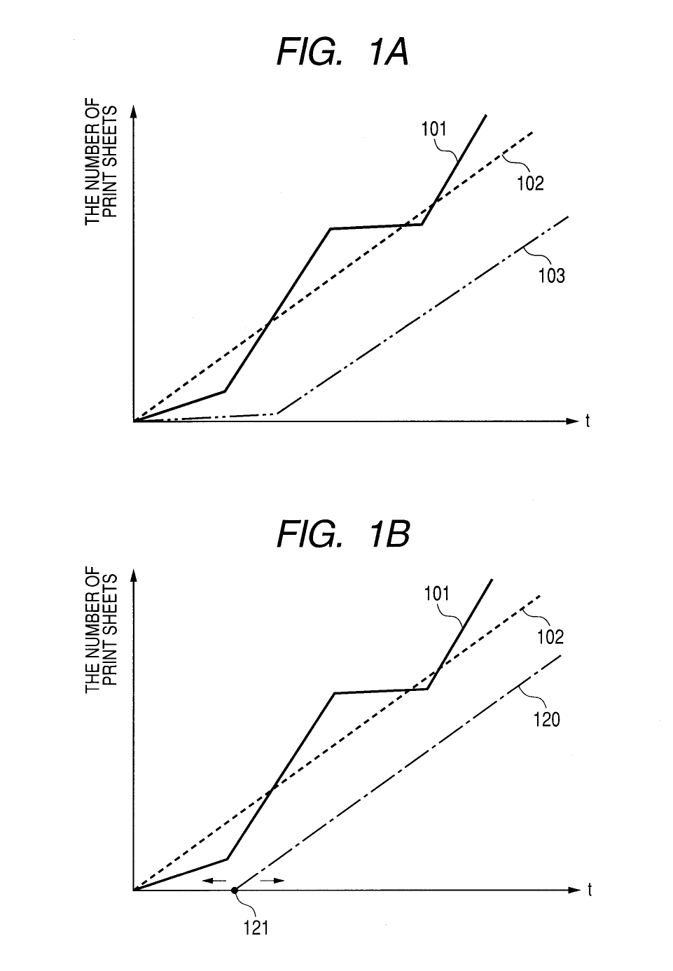

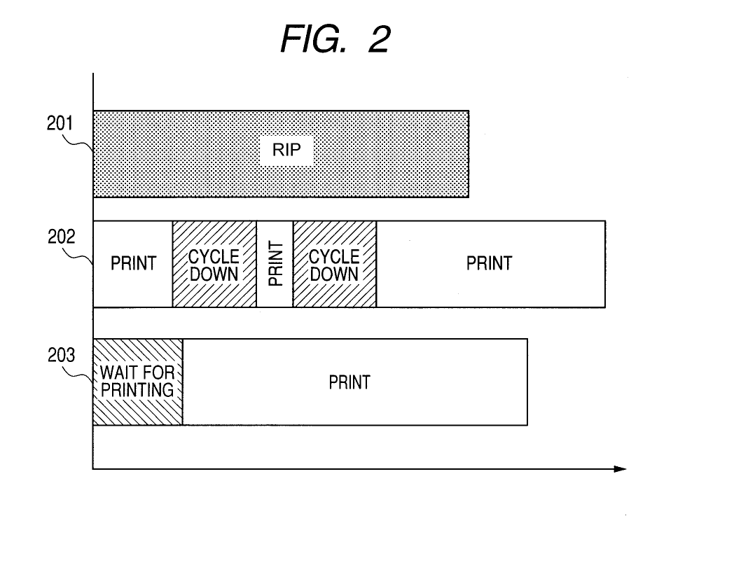

### DESCRIPTION OF EMBODIMENTS

Embodiments of the invention will be described hereinbelow with reference to the drawings.

### Embodiment 1

(Construction of Apparatus)

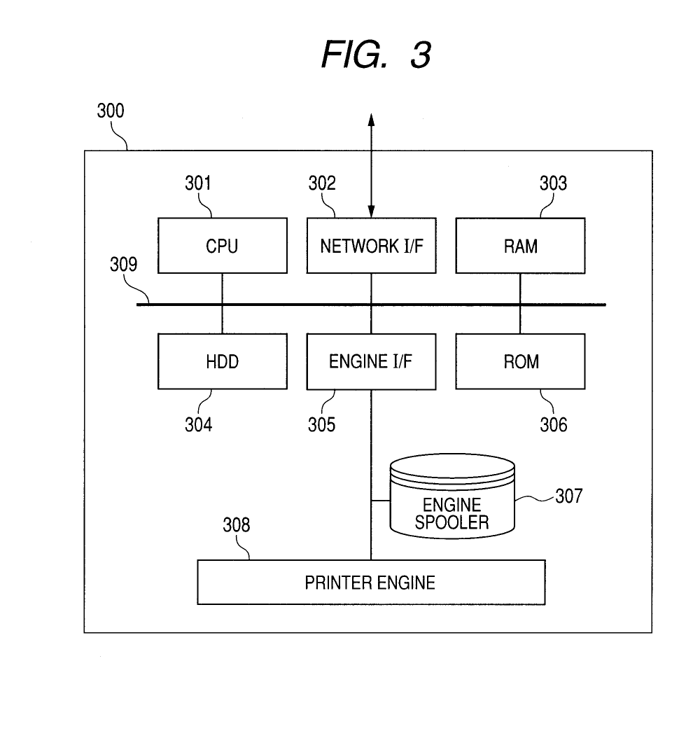

FIG. 3 is a diagram illustrating an example of a hardware construction of a printing apparatus (computer) for executing a variable printing. A printing apparatus 300 has the following construction.

A central processing unit (CPU) 301 performs control and arithmetic operations of each unit in the apparatus and executes a program stored in a storing device through a system bus 309.

A random access memory (RAM) 303 is used as a temporary storage area and a work area in the operation of the printing apparatus. A hard disk drive (HDD) 304 is a storing device of a large capacity. Various kinds of control programs which are executed by the CPU 301 have been stored in the HDD 304. The HDD 304 is also used as a temporary storage area of data which is processed. A ROM 306 is a storing device in which an activation processing program of the printing apparatus has been stored.

A network interface (I/F) 302 is a functional unit for communicating with another apparatus such as a host computer through an external network. An engine interface (I/F) 305 communicates with a printer engine 308 and controls it.

The printer engine 308 is an apparatus for forming an image onto a physical paper surface by using, for example, an electrophotographic technique or an ink jet image forming technique. The printer engine 308 has an engine spooler 307 and temporarily holds page data which is transferred from the engine interface 305.

The CPU 301 executes the programs stored in the HDD 304 or the like, so that processes according to software modules and flowcharts, which will be described hereinafter, are realized.

(Construction of Software Modules)

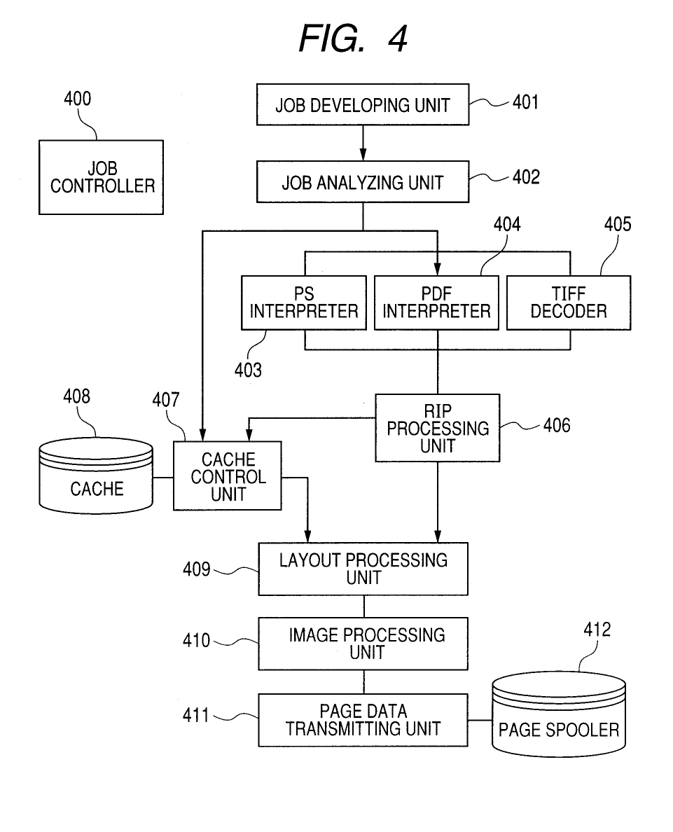

FIG. 4 is a diagram illustrating an example of software modules of the printing apparatus for executing a variable printing.

A job controller 400 is a program for controlling each of the software modules and makes principal control of the control.

A job developing unit 401 inputs a variable print job (print data) received through the network interface (I/F) 302 and develops it. A job analyzing unit 402 analyzes a variable object, a fixed object, and template data included in the developed variable print job.

A PS interpreter 403, a PDF interpreter 404, and a TIFF decoder 405 develop the object included in the developed variable print job and converts into an intermediate data format. An RIP processing unit 406 receives the converted intermediate data format, executes an RIP process, and converts into an image.

A cache control unit 407 manages and controls a cache 408. The cache control unit 407 receives the image from the RIP processing unit 406, stores into the cache, receives an inquiry from the job controller 400, searches the cache 408, and receives or transmits the existing object from/to a layout processing unit 409. The cache 408 maybe provided in the RAM 303 or may be equipped on the HDD 304.

The layout processing unit 409 arranges variable at a and fixed data onto a page based on the template data analyzed by the job analyzing unit 402. An image processing unit 410 executes image processes such as calibration, color conversion, and the like to page data formed by the layout processing unit 409.

A page data transmitting unit 411 stores the page data which has been formed and image-processed into a page spooler 412 and transmits the stored page data to the printer engine 308 based on instructions of the job controller 400. Or, the page data transmitting unit 411 directly transmits the formed and image-processed page data to the printer engine 308. The page spooler 412 may be provided in the RAM 303 or may be equipped on the HDD 304.

(Construction of Variable Print Job)

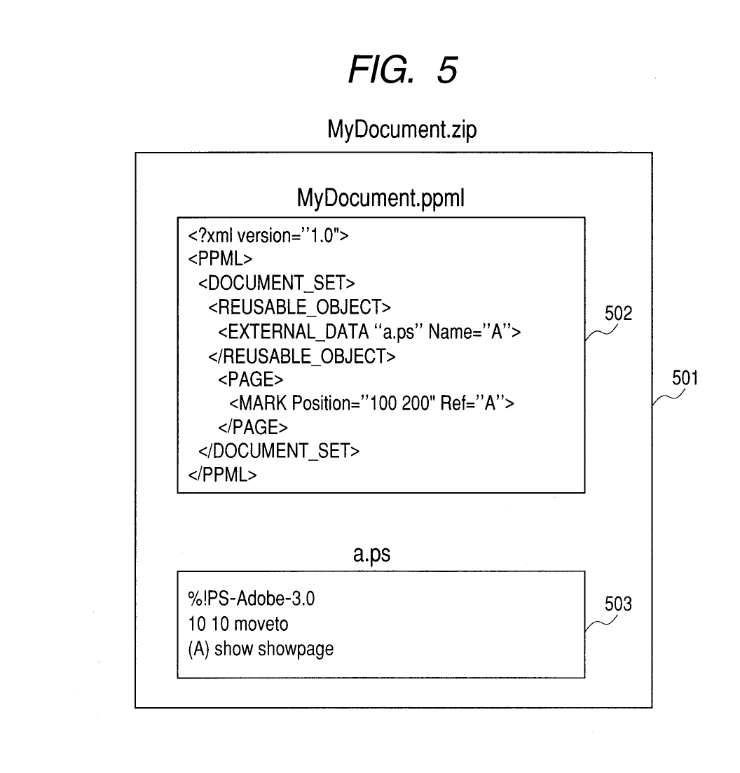

FIG. 5 is a diagram illustrating an example of a construction of a PPML as a variable print job.

An archive file 501 is a library which includes a plurality of files in, for example, a ZIP format and has been compressed. In this example, a PPML file 502 and a contents file 503 have been stored in the archive file 501 named “MyDocument.zip”.

One PPML file 502 has certainly been stored in the archive file 501. The PPML file 502 is template data and a plurality of pages have been defined every record serving as a unit of variation in the variable print job. As for the record, in the case where the contents of the variable print job vary every customer, each customer is defined as one record. For example, in the case where the printing including variable data of 10 pages for each of 50 customers, it is defined that the job has 50 records and each record has 10 pages.

The contents file has been designated as a reference in the PPML file 502. In this example, it is referred to by a file name of a.ps. An attribute showing whether the object is a variable object (variable data) or a reusable object (reusable data) has been added to the contents file which is now referred to. In the example, it is designated that the contents file is the reusable object.

With respect to the contents file 503, although only one contents file has been stored for simplicity in the example of FIG. 5, it is generally constructed by a plurality of contents files. The contents file 503 is described by PostScript. However, in the PPML, it is not limited to PostScript but may be a PDL language such as PDF or the like. A general image format such as TIFF (Tagged Image Format), JPEG (Joint Photographic Experts Group), or the like may be used. That is, the variable print job includes a plurality of records each including a plurality of page data containing either one or both of the variable object and the reusable object.

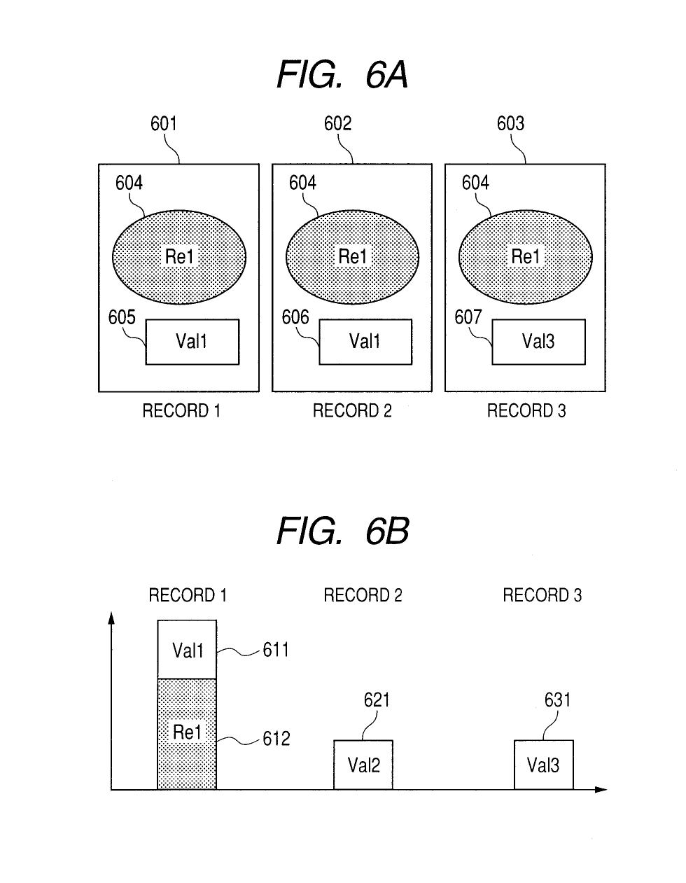

FIG. 6A is a diagram illustrating print results of the variable print job.

Pages 601, 602, and 603 correspond to a record 1, a record 2, and a record 3, respectively. A reusable object 604 corresponds to the contents file 503 serving as a reusable object in FIG. 5. Variable objects 605, 606, and 607 are variable objects (not shown) in FIG. 5.

FIG. 6B is a diagram illustrating an RIP processing time of the variable print job.

In the record 1, the reusable object 604 has to be RIP-processed. Therefore, in addition to an RIP processing time 612 of the reusable object 604, an RIP processing time 611 of the variable object 605 is added. Consequently, it will be understood that a very long processing time is required.

In the records 2 and 3, since the reusable object 604 has already been RIP-processed and stored in the cache 408, the RIP process is unnecessary. Therefore, only RIP processing times 621 and 631 of the variable objects 606 and 607 are required here.

(Variable Printing Flow)

Subsequently, control of the printing apparatus 300 will be described. The job controller 400 of the printing apparatus 300 according to the present flow has been stored as a program in the HDD 304. It is read out into the RAM 303 and executed by the CPU 301.

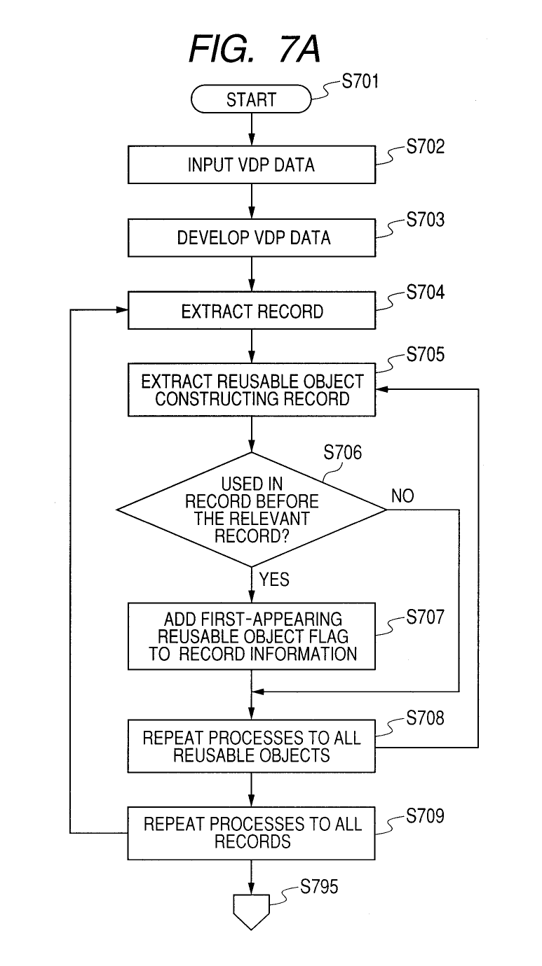

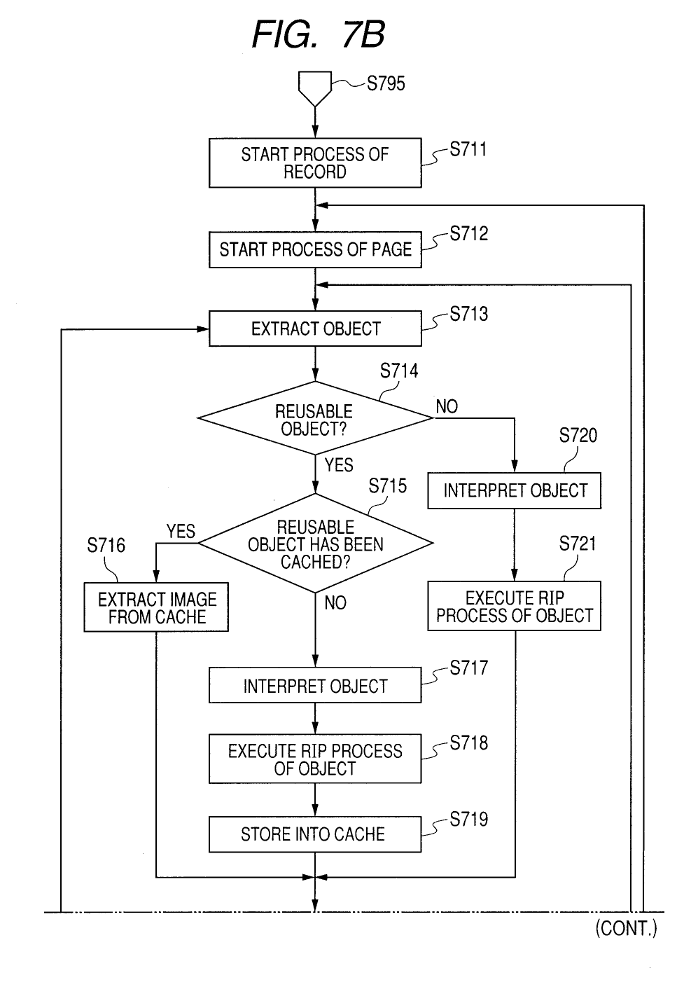

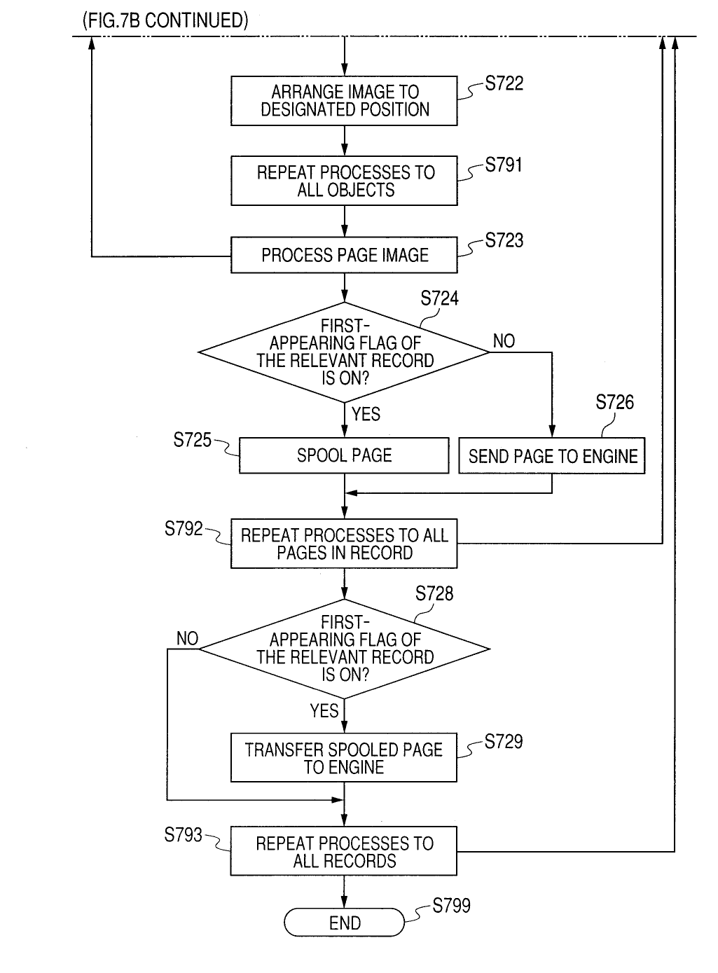

FIGS. 7A and 7B are flowcharts for describing a print process of the printing apparatus 300 in the embodiment 1.

In step S701, the operation of the job controller 400 is started. The network I/F 302 receives the VDP data (S702). Subsequently, the job developing unit 401 develops the received VDP data into the RAM 303 (S703).

In step S704, the job analyzing unit 402 analyzes the developed VDP data, extracts one or more records from the VDP data, and stores into the RAM 303. In step S705, the job analyzing unit 402 extracts the reusable object constructing the extracted record.

In step S706, the job analyzing unit 402 discriminates whether or not the extracted reusable object has been used in the record before the relevant record. That is, the job analyzing unit 402 discriminates whether or not the extracted reusable object is a first-appearing reusable object.

If it is determined in step S706 that the extracted reusable object is the first-appearing reusable object, the job analyzing unit 402 adds a first-appearing reusable object flag to the relevant record information in step S707. If it is determined in step S706 that the extracted reusable object is not the first-appearing reusable object, the process of step S707 is skipped.

The job analyzing unit 402 returns from step S708 to step S705 and repeats the processes of steps S706 and S707 to all of the reusable objects constructing the record. Further, the job analyzing unit 402 returns from step S709 to step S704 and repeats the processes of steps S705 to S708 to all of the records constructing the VDP data.

As mentioned above, the printing apparatus 300 sets the first-appearing reusable object flag to all of the records and advances to the next step (S795).

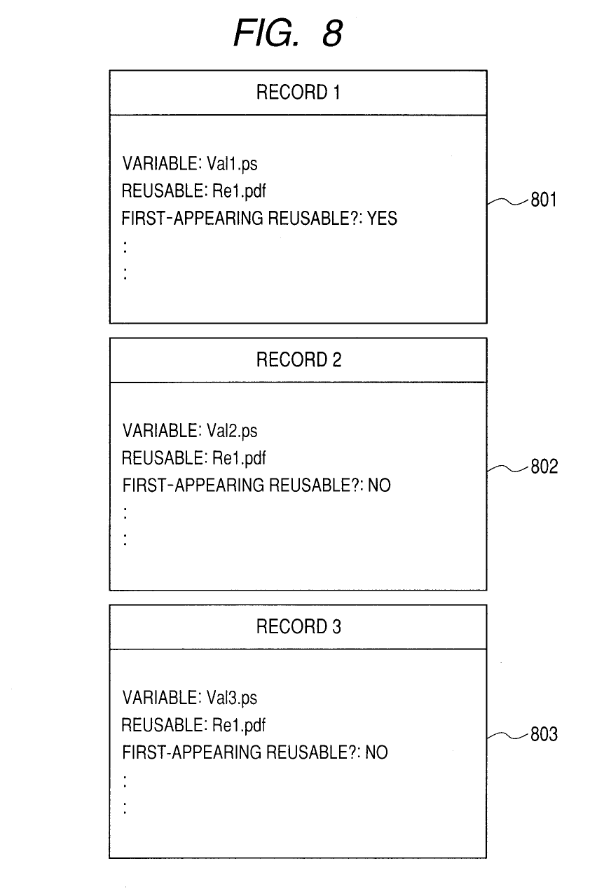

FIG. 8 is a diagram illustrating examples of the developed record information. The record information developed in the RAM 303 by the job analyzing unit 402 has been stored as, for example, a structure. Each of records 801, 802, and 803 holds information necessary to construct the page included in the record. In step S707, the first-appearing reusable object flag is set as illustrated in FIG. 8.

In FIG. 7B, the processing routine advances from step S795 and the job controller 400 sequentially starts processes of the record from the VDP data which has been developed and analyzed (S711). Subsequently, the job controller 400 starts processes about each page included in the record whose processes were started (S712) and extracts the included object (S713).

In step S714, the job controller 400 refers to the developed record information and discriminates whether or not the extracted object is the reusable object. If it is determined in step S714 that the extracted object is not the reusable object, that is, if it is decided that it is the variable object, the job controller 400 interprets the object (S720). At this time, the object is interpreted by using the interpreting unit suitable for the object among the PS interpreter 403, PDF interpreter 404, and TIFF decoder 405. Subsequently, an image is formed by the RIP processing unit 406 (S721). The object image formed in this manner is arranged at the designated position by the layout processing unit 409 (S722).

If it is determined in step S714 that the extracted object is the reusable object, the processing routine advances to step S715 and the job controller 400 inquires of the cache control unit 407. Thus, the job controller 400 discriminates whether or not the reusable object has been cached.

If it is determined in step S715 that the reusable object has been cached, the job controller 400 instructs the cache control unit 407 to extract the cached reusable object from the cache 408. The object image extracted from the cache 408 in this manner is arranged at the designated position by the layout processing unit 409 (S722).

If it is determined in step S715 that the reusable object is not cached, the job controller 400 interprets the object (S717). At this time, the object is interpreted by using the interpreting unit suitable for the object among the PS interpreter 403, PDF interpreter 404, and TIFF decoder 405. Subsequently, an image is formed by the RIP processing unit 406 (S718).

In step S719, the job controller 400 instructs the cache control unit 407 to store the formed image into the cache 408. In parallel with it, the job controller 400 instructs the layout processing unit 409 to arrange the formed image to the designated position.

In step S791, the job controller 400 repeats the processes of steps S713 to S722 to all of the objects constructing the relevant page, so that a page image is formed. The job controller 400 executes image processes to the formed page image by the image processing unit 410 (S723).

In step S724, the job controller 400 refers to the record information and discriminates whether or not the first-appearing reusable object flag has been set into the relevant record. If it is determined in step S724 that the first-appearing reusable object flag is ON, the job controller 400 stores the formed page image into the page spooler 412 (S725). If it is determined in step S724 that the first-appearing reusable object flag is OFF, the job controller 400 transmits the formed page image to the engine by the page data transmitting unit 411 (S726).

In step S792, the job controller 400 repeats the processes of steps S712 to S725/S726 to all of the pages of the relevant record. Thus, in the record in which the first-appearing reusable object flag is ON, the page is spooled. In the record in which the flag is OFF, simultaneously with that the page is formed, it is successively transmitted to the engine.

Subsequently, in step S728, the job controller 400 discriminates whether or not the first-appearing reusable object flag of the relevant record is ON. If it is determined in step S728 that the first-appearing reusable object flag of the relevant record is ON, the job controller 400 extracts all pages of the record stored in the page spooler 412. The page data transmitting unit 411 transmits the pages of the record stored in the page spooler 412 to the engine (S729).

In step S793, the job controller 400 repeats the processes of steps S711 to S729 to all of the records and finishes the processing routine in step S799.

By the above processes, the RIP-Then print can be executed for the record including the first-appearing reusable object and the RIP-While print can be executed for the record which does not include the first-appearing reusable object.

(Improvement of Speed in Variable Printing)

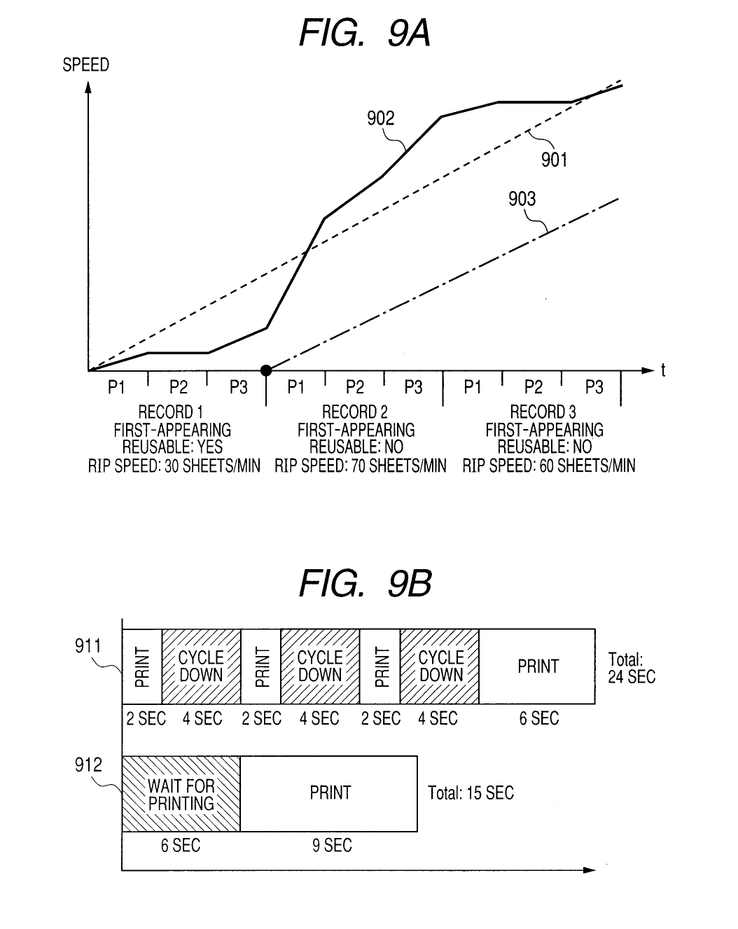

FIG. 9A is a diagram illustrating an example of an RIP speed and an engine speed in the variable print job. It is assumed that the printing apparatus 300 is a printing apparatus which can print 60 sheets per minute (every minute).

A graph 901 is a graph showing an ideal print speed of 60 sheets per minute. It is assumed that the VDP data which is printed is data of a plurality of records and is data including three pages per record. In the record 1, since there are first-appearing reusable objects, a time is consumed to execute the RIP processes of them. Thus, the average RIP speed of three pages included in the record 1 is equal to an output speed of 30 sheets per minute.

A graph 902 is a graph showing an RIP speed of the VDP data which is printed. In the records 2 and 3, the first-appearing reusable object does not exist. Therefore, in those records, since it is sufficient to execute only the RIP process of the variable object, the RIP speeds are equal to 70 sheets/minute and 60 sheets/minute, respectively.

A graph 903 shows an actual print speed of the printing apparatus 300 in the embodiment 1. According to the processes in the embodiment 1, the pages are spooled to the record 1 until the RIP processes to all of the three pages are finished, and thereafter, the image is transferred to the engine side. Therefore, the printing is automatically started after completion of the record 1. Thus, it will be understood that such a situation that in the record of the reduced RIP speed, the RIP speed does not overtake the print speed and the cycle down occurs can be avoided.

FIG. 9B is a diagram illustrating examples of the variable print job in the embodiment 1 and a total print time of the RIP-While print in the related art. A graph 911 shows the total print time of the RIP-While print in the related art. A graph 912 shows the total print time in the variable printing in the embodiment 1.

In the graph 911, according to the RIP-While print in the related art, since the RIP process is executed and the page image is successively transferred to the engine, in the record 1, the RIP speed does not overtake the engine speed and the cycle down occurs. It is now assumed that a time of the cycle down is equal to 4 seconds. Since the RIP speed of the record 1 is equal to 30 sheets/minute, the print time of 2 seconds is required to execute the RIP process of one sheet. That is, although the ideal print time of the engine is one second per sheet, the print time of at least 6 seconds per sheet is required in consideration of the cycle down. In the record 2 and subsequent records, since the cache sufficiently shows an effect, the printing can be performed for 1 second per sheet. Therefore, a time which is required to print remaining six sheets is equal to 6 seconds. Consequently, in the RIP-While print in the related art, the print time of 24 seconds is required in total.

In the variable printing in the embodiment 1, the pages are spooled until all of the three pages of the first record are RIP-processed. A time which is required to print the three pages is equal to 6 seconds (2 seconds×3 sheets). After waiting for the printing of 6 seconds, the formed page image is transferred to the engine. However, since the cycle down does not occur, 9 sheets can be printed for 9 seconds (1 second per sheet×9 sheets). In the variable printing in the embodiment 1, therefore, the time of only 15 seconds is required in total and such an effect that the printing can be performed at a speed higher than that in the RIP-While print in the related art is obtained.

Although the print start page number has to be manually set every VDP job in the Gallop mode printing in the related art as mentioned above, in the variable printing in the embodiment 1, the record which needs a time for the RIP process can be automatically discriminated and the print waiting can be performed.

Subsequently, a case where there are no first-appearing reusable objects in the first record and the first-appearing reusable objects exist in the second and subsequent records will be considered.

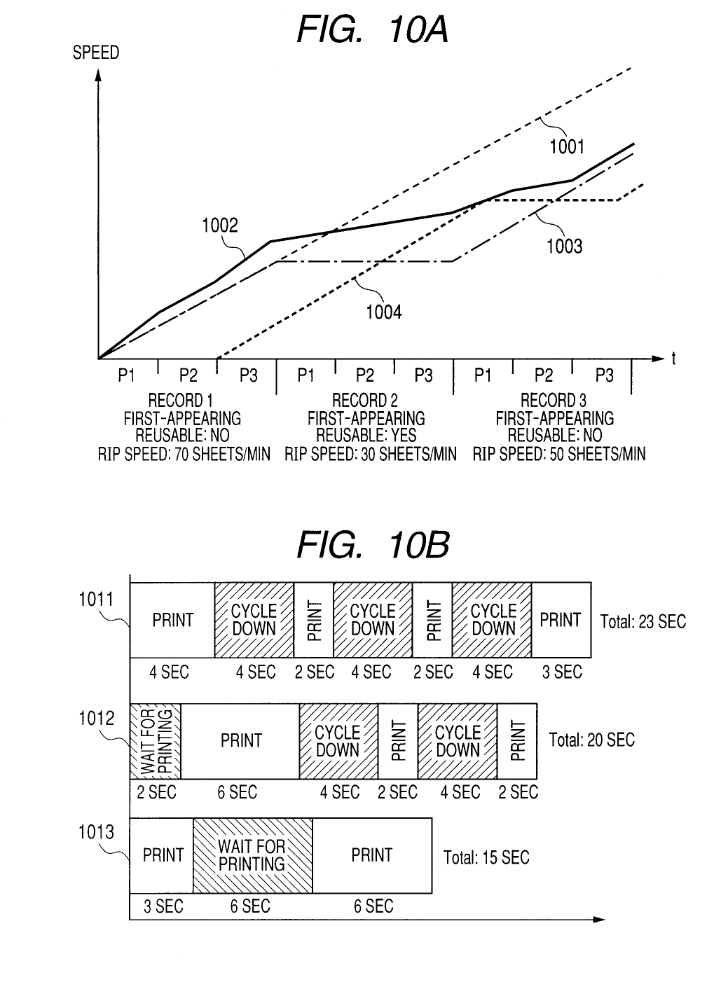

FIG. 10A is a diagram illustrating an example of an RIP speed and an engine speed in the variable print job in the embodiment 1. In a manner similar to FIG. 9A, a graph 1001 is a graph showing an ideal print speed of 60 sheets/minute. A graph 1002 shows an RIP speed. A graph 1003 shows an actual print speed of the printing apparatus in the embodiment 1. A graph 1004 shows an actual print speed of the Gallop mode printing in the related art. However, the print start page number is set to the second page.

According to the processes in the embodiment 1, the RIP-While print is executed to the record 1. However, in the record 1, since the RIP speed is higher than the engine speed, the printing can be performed at the engine speed. In the record 2, since the first-appearing reusable objects exist, all of the three pages are spooled until the page images are formed. Therefore, in the record 2, the engine stops. In the record 3, although the RIP-While print is executed again, after the image which was RIP-processed in the record 2 was transferred to the engine, the page images are successively transferred.

FIG. 10B is a graph illustrating examples of the variable print job in the embodiment 1 and a total print time of the RIP-While print in the related art and the Gallop mode printing in the related art. A graph 1011 shows the total print time of the RIP-While print in the related art. A graph 1012 shows the total print time in the Gallop mode printing in the related art. However, the print start page number is set to the second page. A graph 1013 shows the total print time of the variable printing in the embodiment 1.

In the graph 1011, in the RIP-While print in the related art, a print time of 23 seconds is required in total. In the Gallop mode printing in the related art, after waiting for the printing of 2 pages for 2 seconds, the printing is started. However, in the VDP job illustrated in FIG. 10A, since the RIP speed has been reduced in the record 2, the RIP speed is overtaken by the print time of the Gallop mode at the first page of the record 3 and the cycle down occurs. Therefore, also in the Gallop mode printing in the related art, the total print time is equal to 20 seconds. Also in the Gallop mode printing in the related art, it cannot cope with a case where the RIP speed is overtaken in the halfway.

In the variable printing in the embodiment 1, even in the case where the RIP speed is reduced in the record in the halfway and is overtaken by the actual print speed, such a situation that the cycle down continues automatically is avoided and the printing can be performed at a high speed.

### Embodiment 2

In the embodiment 1, whether or not the first-appearing reusable objects are included is discriminated on a record unit basis, and the RIP-While print and the RIP-Then print are switched based on a discrimination result. However, even if a certain record includes the first-appearing reusable objects, there is a case where they are concentrated on one position among a plurality of pages. In such a case, only an interval where the reusable objects exist concentratedly has a possibility of causing the cycle down. Such an operation that all of the pages contained in the record are RIP-Then printed is inefficient. Therefore, the embodiment 2 will be described with respect to a process for discriminating an interval where the first-appearing reusable objects continue from the VDP data will be described.

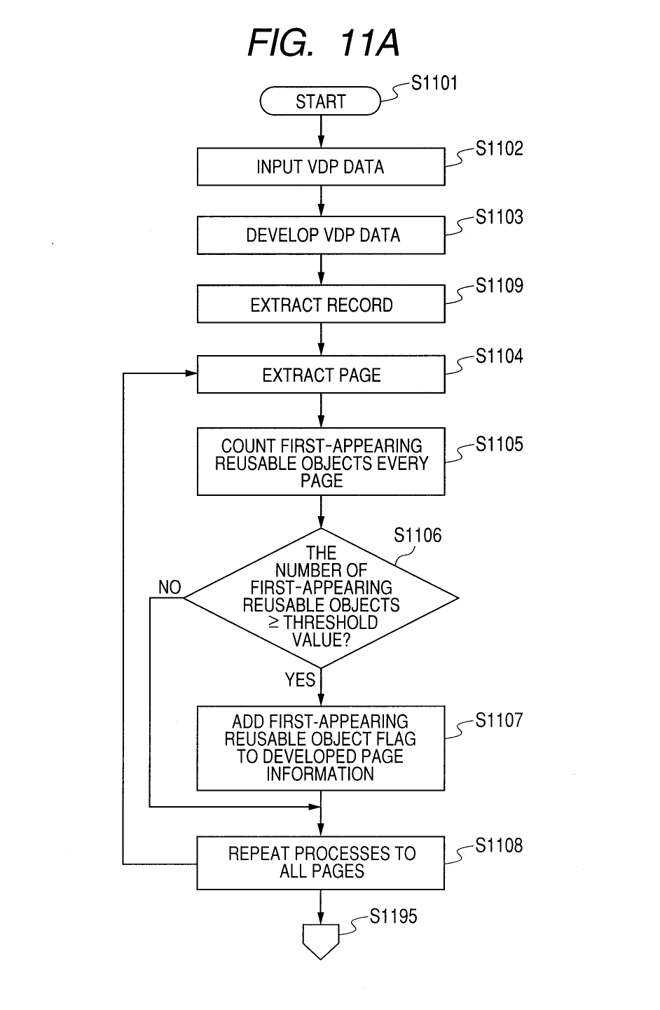

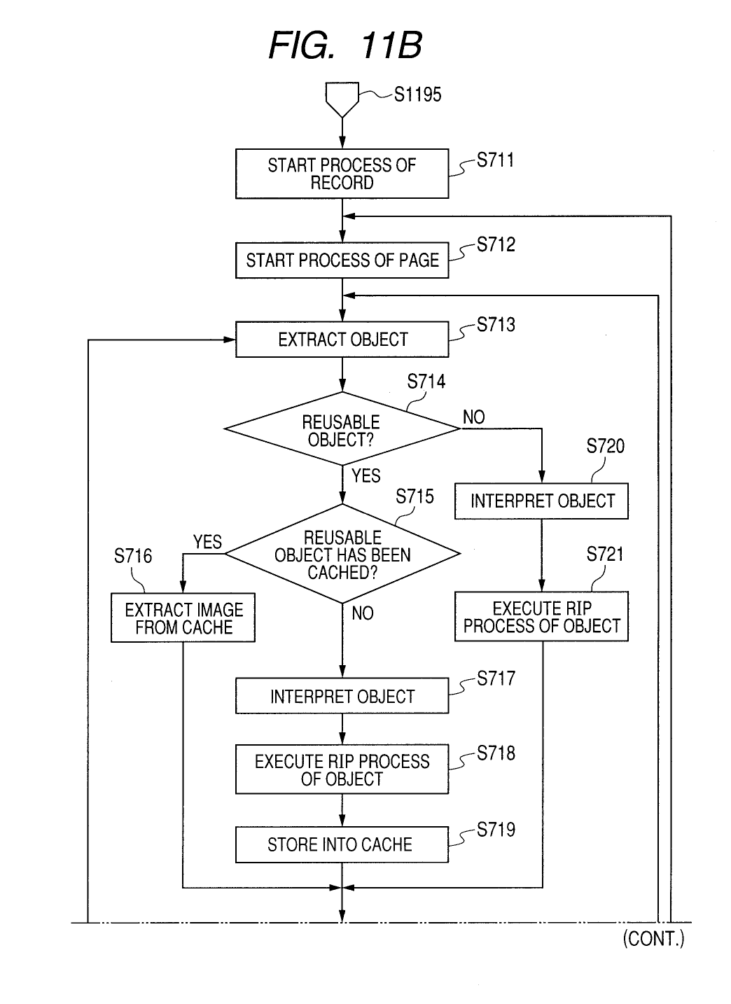

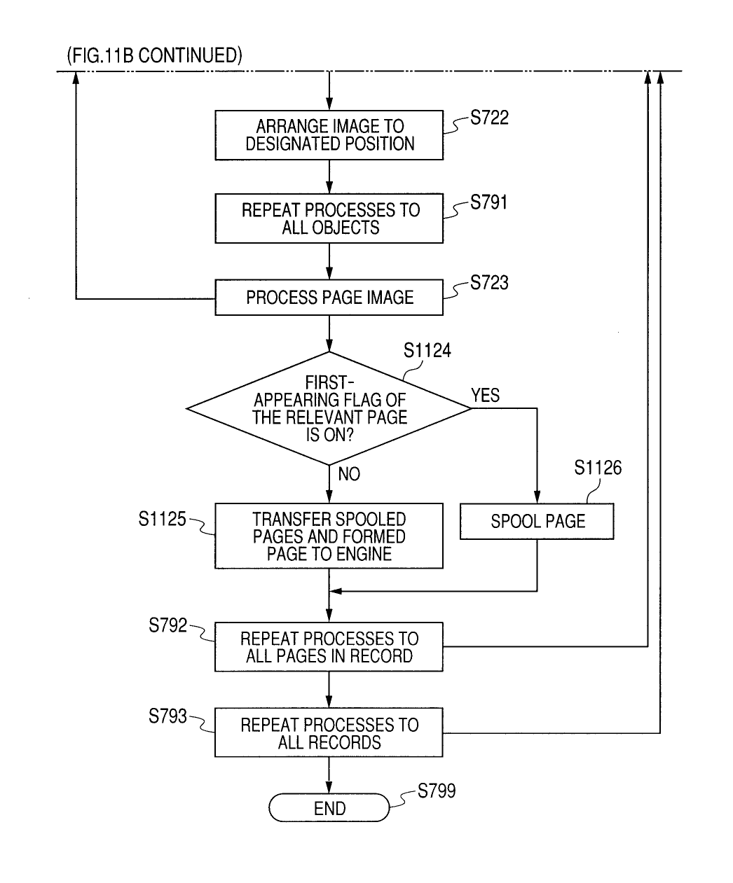

FIGS. 11A and 11B are flowcharts for describing a print process of the printing apparatus 300 in the embodiment 2.

The operation of the job controller 400 is started in step S1101. The network I/F 302 receives the VDP data (S1102). Subsequently, the job developing unit 401 develops the received VDP data into the RAM 303 (S1103).

In step S1109, the job analyzing unit 402 analyzes the developed VDP data, extracts one or more record information from the VDP data, and stores into the RAM 303. In step S1104, the job analyzing unit 402 analyzes the developed VDP data, extracts one or more page information from the VDP data, and stores into the RAM 303.

In step S1105, the job analyzing unit 402 counts the number of first-appearing reusable objects (the number of first-appearing reusable data) which are used every extracted page. More specifically describing, the job analyzing unit 402 extracts the reusable objects every extracted page. When the first-appearing reusable objects are included in the extracted reusable objects, the job analyzing unit 402 counts the number of first-appearing reusable objects every page data.

In step S1106, the job analyzing unit 402 discriminates whether or not the counted number of first-appearing reusable objects is equal to or larger than a preset threshold value (not shown) stored in the RAM 303. If it is determined in step S1106 that the number of first-appearing reusable objects is equal to or larger than the threshold value, the job analyzing unit 402 adds the first-appearing reusable object flag to the developed page information (S1107). If it is determined in step S1106 that the number of first-appearing reusable objects is smaller than the threshold value, the job analyzing unit 402 skips the process of step S1107.

In step S1108, the job analyzing unit 402 repeats the processes of steps S1104 to S1107 to all of the pages and advances to the next flow (S1195). In step S1195, the job controller 400 executes the processes of steps S711 to S723 in the embodiment 1.

In step S1124, the job controller 400 discriminates whether or not the first-appearing reusable object flag is ON in the page information associated with the pages formed before step S723. If it is determined in step S1124 that the flag is ON, the job controller 400 stores the formed page images into the page spooler 412 (S1126). If it is determined in step S1124 that the flag is OFF, the job controller 400 refers to the page spooler 412, sequentially transfers the stored page images to the engine, and thereafter, transfers the formed page images to the engine (S1125).

In step S792, the job controller 400 repeats the processes of steps S713 to S1125/S1126 and executes the processes to the pages in all of the records. Further, in step S793, the job controller 400 repeats the processes of steps S712 to S792, executes the processes to all of the records, and finishes the processing routine in step S799.

According to the foregoing processes, in the interval where the first-appearing reusable objects continue, the RIP-Then print can be executed, and in other intervals, the RIP-While print can be executed.

### Embodiment 3

In the embodiment 2, the method of discriminating the page interval where the first-appearing reusable objects are concentrated based on the number of first-appearing reusable objects has been described. However, for example, in the case where the reusable object is line head characters of an itemization, in spite of a fact that the time required for the RIP process is short, in the embodiment 2, it is determined as a page interval where the first-appearing reusable objects exist. There is, consequently, a possibility that in spite of a fact that a possibility of the cycle down is low, the RIP-Then print is executed in the page interval. In the embodiment 3, therefore, a process of using an area ratio of the first-appearing reusable objects will be described.

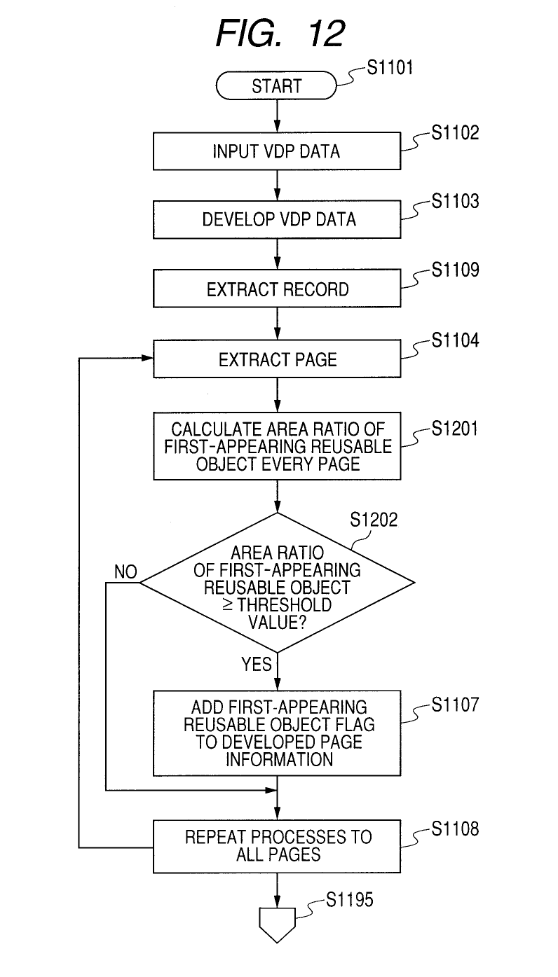

FIG. 12 is a flowchart for describing a print process for discriminating the first-appearing reusable object interval in the embodiment 3.

In a manner similar to the embodiment 2, the job controller 400 executes the processes of steps S1101 to S1104 and extracts pages.

In step S1201, the job analyzing unit 402 calculates an area ratio of the first-appearing reusable objects every page. It is calculated based on a ratio of the area which is occupied by the first-appearing reusable objects to the page size.

Subsequently, in step S1202, the job analyzing unit 402 discriminates whether or not the calculated area ratio of the first-appearing reusable objects is equal to or larger than a preset threshold value (not shown) stored in the RAM 303. After that, by executing processes similar to the processing steps in the embodiment 2, the job controller 400 discriminates the first-appearing reusable object interval based on the area ratio and prints.

According to the foregoing processes, in the interval where the pages in which the area ratio of the first-appearing reusable objects is large continue, the RIP-Then print can be executed, and in other intervals, the RIP-While print can be executed.

### Embodiment 4

In the embodiment 3, the process for discriminating the page interval where the first-appearing reusable objects are concentrated based on the area ratio of the first-appearing reusable objects has been described. However, even in a reusable object having a large area ratio, for example, in the case of a simple object such as a rectangle, a time which is required for the RIP process is short. In spite of such a fact, in the embodiment 3, it is determined as a page interval where the first-appearing reusable objects exist. Consequently, in spite of a fact that a possibility of the cycle down is low, there is a possibility that the RIP-Then print is executed in the page interval. Therefore, the embodiment 4 will be described with respect to a process using an object size of the first-appearing reusable object.

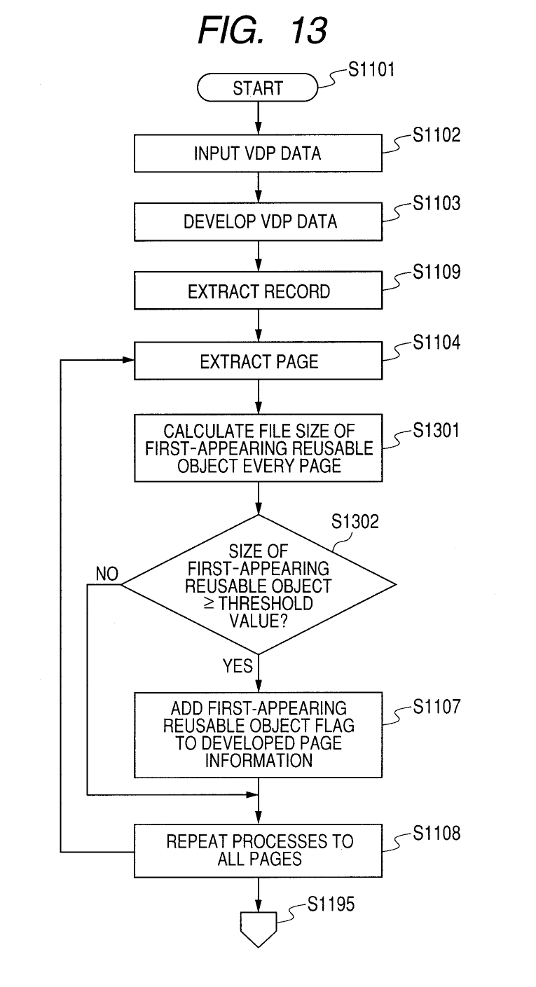

FIG. 13 is a flowchart for describing a print process for discriminating the first-appearing reusable object interval in the embodiment 4.

In a manner similar to the embodiment 3, the job controller 400 executes the processes of steps S1101 to S1104 and extracts a page.

In step S1301, the job analyzing unit 402 calculates a file size of the first-appearing reusable objects every page. It is calculated by the sum of data sizes of the relevant object.

Subsequently, in step S1302, the job analyzing unit 402 discriminates whether or not the calculated file size of the first-appearing reusable objects is equal to or larger than a preset threshold value (not shown) stored in the RAM 303. After that, by executing processes similar to the processing steps in the embodiment 3, the job controller 400 discriminates the first-appearing reusable object interval based on the area ratio and prints.

According to the foregoing processes, in the interval where the pages in which the file size of the first-appearing reusable objects is large continue, the RIP-Then print can be executed, and in other intervals, the RIP-While print can be executed.

### Other Embodiments

In the embodiment 2, the process for detecting the interval based on the number of first-appearing reusable objects has been described. In the embodiment 3, the process for detecting the interval based on the area ratio of the first-appearing reusable objects has been described. In the embodiment 4, the process for detecting the interval based on the file size of the first-appearing reusable objects has been described.

However, the processes in the embodiments 2 to 4 can be also applied to the process for discriminating the record including the first-appearing reusable objects in the embodiment 1. In the case where the processes in the embodiments 2 to 4 are applied to the process for discriminating the record including the first-appearing reusable objects in the embodiment 1, the processes which are executed every page in the processes in the embodiments 2 to 4 are executed every record. Further, the interval can be also detected at higher precision by a combination of the embodiments 2 to 4.

The foregoing embodiments can be also realized by executing the following processes. That is, software (program) for realizing the functions of the embodiments mentioned above is supplied to a system or apparatus through a network or various kinds of storing media, a computer (or CPU, MPU, or the like) of the system or apparatus reads out the program and executes processes based on it.

Although the exemplary embodiments of the invention have been described in detail above, the invention is not limited to the foregoing specific embodiments but various modifications and changes are possible within the purview of the spirit of the invention disclosed in claims.

This application claims the benefit of Japanese Patent Application No. 2009-217267, filed Sep. 18, 2009, which is hereby incorporated by reference herein in its entirety.

1. A printing apparatus comprising:
an input unit configured to input print data including a plurality of records each including a plurality of page data each containing either one or both of reusable data and variable data;
an extracting unit configured to extract the reusable data every record;
an adding unit configured to, when the reusable data which has been extracted for the first time in the print data is included in the reusable data extracted by the extracting unit, add information to the record including the first-extracted reusable data;
a forming unit configured to form a page image every page data included in the record; and
a transfer unit configured to, in the case where the information has been added to the record, hold the page images which are formed by the forming unit until the page images of all of the page data included in the record are formed by the forming unit and transfer the held page images of all of the page data included in the record to a printer engine, and in the case where the information is not added to the record, each time the page image of the page data included in the record is formed by the forming unit, transfer the formed page image to the printer engine.

2. A printing apparatus according to claim 1, wherein when the reusable data extracted for the first time in the print data is included in the reusable data extracted by the extracting unit, the adding unit counts the number of first-appearing reusable data every record and adds the information to the record in which the counted number of first-appearing reusable data is equal to or larger than a threshold value.

3. A printing apparatus according to claim 1, wherein when the reusable data extracted for the first time in the print data is included in the reusable data extracted by the extracting unit, the adding unit calculates an area ratio of the first-extracted reusable data to the record every record and adds the information to the record in which the calculated area ratio is equal to or larger than a threshold value.

4. A printing apparatus according to claim 1, wherein when the reusable data extracted for the first time in the print data is included in the reusable data extracted by the extracting unit, the adding unit calculates a file size of the first-extracted reusable data every record and adds the information to the record in which the calculated file size is equal to or larger than a threshold value.

5. A printing apparatus comprising:
an input unit configured to input print data including a plurality of records each including a plurality of page data each containing either one or both of reusable data and variable data;
an extracting unit configured to extract the reusable data every page data included in the record;
an adding unit configured to, when the reusable data which has been extracted for the first time in the print data is included in the reusable data extracted by the extracting unit, add information to the page data including the reusable data;
a forming unit configured to form a page image every page data included in the record; and
a transfer unit configured to, in the case where the information has been added to the page data of the page image formed by the forming unit, hold the page images formed by the forming unit, and in the case where the information is not added to the page data of the page image formed by the forming unit, transfer the page image formed by the forming and the page images which have already been held to a printer engine.

6. A printing apparatus according to claim 5, wherein when the reusable data extracted for the first time in the print data is included in the reusable data extracted by the extracting unit, the adding unit counts the number of first-appearing reusable data every page data and adds the information to the page data in which the counted number of first-appearing reusable data is equal to or larger than a threshold value.

7. A printing apparatus according to claim 5, wherein when the reusable data extracted for the first time in the print data is included in the reusable data extracted by the extracting unit, the adding unit calculates an area ratio of the first-extracted reusable data to the record every page data and adds the information to the page data in which the calculated area ratio is equal to or larger than a threshold value.

8. A printing apparatus according to claim 5, wherein when the reusable data extracted for the first time in the print data is included in the reusable data extracted by the extracting unit, the adding means calculates a file size of the first-extracted reusable data every page data and adds the information to the page data in which the calculated file size is equal to or larger than a threshold value.

9. A printing method carried out in a printing apparatus, the method comprising:
inputting print data including a plurality of records each including a plurality of page data each containing either one or both of reusable data and variable data;
extracting the reusable data every record;
when the reusable data which has been extracted for the first time in the print data is included in the reusable data extracted in the extracting step, adding information to the record including the first-extracted reusable data;
forming a page image every page data included in the record;
in the case where the information has been added to the record, holding the page images which are formed in the forming step until the page images of all of the page data included in the record are formed in the forming step and transferring the held page images of all of the page data included in the record to a printer engine; and
in the case where the information is not added to the record, each time the page image of the page data included in the record is formed in the forming step, transferring the formed page image to the printer engine.

10. A printing method carried out in a printing apparatus, the method comprising:
inputting print data including a plurality of records each including a plurality of page data each containing either one or both of reusable data and variable data;
extracting the reusable data every page data included in the record;
when the reusable data which has been extracted for the first time in the print data is included in the reusable data extracted in the extracting, adding information to the page data including the reusable data;
forming a page image every page data included in the record; and
in the case where the information has been added to the page data of the page image formed in the forming step, holding the page images formed in the forming; and
in the case where the information is not added to the page data of the page image formed in the forming step, transferring the page image formed in the forming step and the page images which have already been held to a printer engine.

11. A non-transitory computer-readable storage medium for storing a program for causing a computer to execute a printing method according to claim 9.

12. A non-transitory computer-readable storage medium for storing a program for causing a computer to execute a printing method according to claim 10.
